(19) United States
(12) Patent Application Publication
(10) Pub. No.: US 2007/0080531 A1
(43) Pub. Date: Apr. 12, 2007

(54) Impact absorbing device for steering column of vehicle

(75) Inventor: Jun Yong Min, Gyeonggi-do (KR)

Correspondence Address: EDWARDS & ANGELL, LLP, P.O. BOX 55874, BOSTON, MA, 02205, US

(73) Assignee: Hyundai Motor Company, Seoul (KR)

(21) Appl. No.: 11/298,645

(22) Filed: Dec. 8, 2005

(30) Foreign Application Priority Data
Oct. 6, 2005 (KR) 2005-0093965

(51) Int. Cl. B62D 1/00

(52) U.S. Cl. 280/777; 280/779

(57) ABSTRACT

Disclosed is an impact absorbing device for a steering column of a vehicle. The impact absorbing device includes a bearing and a pipe additionally and the structure of the mounting bracket is modified so that the bearing member and a torque bolt are installed thereto. Therefore, since capsules and the torque bolt are broken in the case of collision of a vehicle, the impact transfer to a shaft through a gear shaft can be prevented, thereby preventing excessive impact and interference with peripheral parts.

### CROSS-REFERENCE TO RELATED APPLICATION

This application claims priority to and the benefit of Korean Patent Application 10-2005-0093965 filed in the Korean Intellectual Property Office on Oct. 6, 2005, the entire content of which is incorporated herein by reference.

### FIELD OF THE INVENTION

The present invention relates to an impact absorbing device for a steering column of a vehicle, and more particularly to an impact absorbing device for a steering column of a vehicle capable of preventing application of excessive impact to a steering column in the case of the vehicle's collision and preventing a steering column from interfering with surrounding parts.

### BACKGROUND

Generally, if the vehicle sustains a frontal collision to the front during operation of the vehicle, the upper body of the driver, which is inclined to the front by inertial force, collides with the steering wheel or a steering shaft, to which the steering wheel is mounted, is pushed upward on the driver side of the vehicle, and then collides with the upper body of the driver. Therefore, a conventional steering column to which a steering wheel is mounted so as to allow a driver to change the direction of a moving vehicle has a structure for absorbing an impact.

As shown in FIG. 1, a conventional steering column includes a gear shaft 1 having a steering wheel at one end thereof and having an engaging portion 6 engaged with a universal joint at the other end thereof, a steering shaft 2 separated from the outer peripheral surface of the gear shaft 1, a friction tube 3 installed between the gear shaft 1 and a steering shaft 2 so as to be moved in case a collision of the vehicle occurs, a mounting bracket 4 mounted to the steering shaft 2 to be engaged with the vehicle body, and capsules 5 being installed on both sides of the mounting bracket 4 so as to be broken in the case of collision of the vehicle.

Therefore, if the vehicle sustains a collision, the capsules 5 installed in the mounting bracket 4 are broken and the friction tube 3 is moved, generating friction in order to absorb an impact.

However, according to the above-mentioned structure, a phenomenon in which the impact of the vehicle is directly transferred to the steering shaft 2 by the frictional movement of the friction tube 3 (i.e. a phenomenon in which the impact is excessively distributed to the entire steering column in the case of collision, due to the distribution of the impact load by the frictional tube) is generated, and thus the impact applied to a driver is not absorbed but is directly transferred, thereby causing serious damage to the driver.

Further, since the steering column is connected to peripheral parts such as brake and accelerator pedals, interference is generated between the steering column and the peripheral parts.

The information set forth in this Background of the Invention section is only for enhancement of understanding of the invention and should not be taken as an acknowledgement or any form of suggestion that this information forms the prior art that is already known to a person skilled in the art.

### SUMMARY OF THE INVENTION

In one aspect, an impact absorbing device for a steering column of a vehicle is provided which includes a bearing member and a pipe, in which capsules and a torque bolt are broken in the case of collision of the vehicle. This is accomplished by modifying the structure of a mounting bracket so that the bearing member and the torque bolt is installed in the mounting bracket and the pipe is slid along the main body of the steering column, thereby preventing excessive impact and interference with peripheral parts.

According to a preferred embodiment of the present invention, there is provided an impact absorbing device for a steering column of a vehicle, which comprises: a steering shaft separated from the outer peripheral surface of a steering gear shaft by a predetermined interval, in which a steering wheel is installed at one end of the steering shaft; a mounting bracket for attaching the steering shaft to the body of a vehicle, the mounting bracket having a nut hole and a moving hole on one side thereof, and having a mounting portion and curling plates for absorbing an impact on the other side thereof; a pipe movably installed between the steering gear shaft and the steering shaft; capsules installed at both ends of the mounting portion and connected to the pipe, the capsule being broken when an impact occurs; and a bearing member mounted to a lower portion of the steering gear shaft and movably engaged with the mounting bracket by the moving hole.

According to an embodiment of the present invention, the impact absorbing device further comprises: a connecting member connecting the mounting bracket and the bearing member.

According to an embodiment of the present invention, the pipe is moved by the movement of the steering gear shaft.

According to an embodiment of the present invention, the pipe is separated from the steering shaft by a predetermined interval.

According to an embodiment of the present invention, the bearing member is not moved in the lengthwise direction of the steering gear shaft but is moved in the circumferential direction of the steering gear shaft.

According to an embodiment of the present invention, the connecting member is engaged with the nut hole of the mounting bracket by a torque bolt which is broken when an impact occurs.

According to an embodiment of the present invention, the material of the capsules and the torque bolt is a synthetic resin.

According to an embodiment of the present invention, the capsules and the torque bolt are simultaneously broken when the vehicle sustains a collision.

The invention also includes vehicles particularly motor vehicles such as automobiles, trucks and the like that comprise an impact absorbing device for a steering column as described herein.

It is understood that the term “vehicle” or “vehicular” or other similar terms as used herein is inclusive of motor vehicles in general such as passenger automobiles, buses, trucks, various commercial vehicles, watercraft including a variety of boats, aircraft, and the like.

Other aspects of the invention are discussed below.

### BRIEF DESCRIPTION OF THE DRAWINGS

The above and other objects, features and advantages of the present invention will be more apparent from the following detailed description taken in conjunction with the accompanying drawings, in which:

FIG. 1 is a view for showing a conventional impact absorbing device for a steering column of a vehicle;

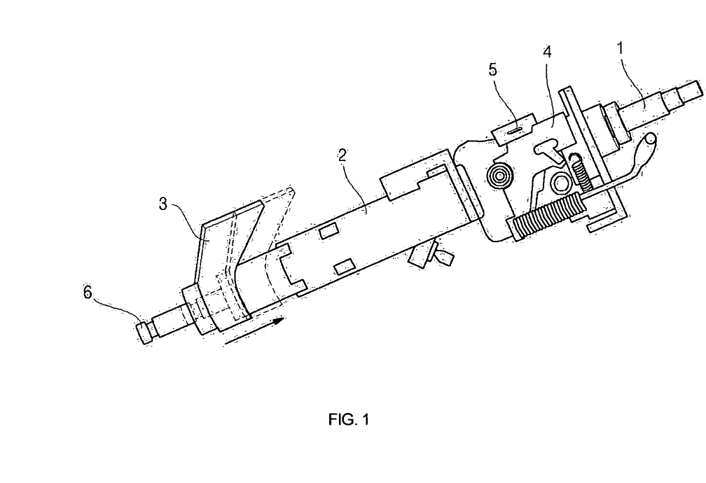

FIG. 2 is a view for showing an impact absorbing device for a steering column of a vehicle according to the present invention;

FIG. 3 is an enlarged view of portion A of FIG. 2, which shows a state of a vehicle after a collision; and

FIG. 4 is an engagement cross-sectional view for showing a gear shaft, a shaft, a pipe, and a bearing member.

### DETAILED DESCRIPTION OF THE PREFERRED EMBODIMENTS

As discussed above, an impact absorbing device for a steering column of a vehicle is provided which in preferred aspects comprises: (1) a steering shaft which is preferably separated from the outer peripheral surface of a steering gear shaft by a predetermined interval, and preferably in which a steering wheel is installed at one end of the steering shaft; (2) a mounting bracket for attaching the steering shaft to the body of a vehicle and configured to absorb impact; (3) a pipe movably installed between the steering gear shaft and the steering shaft; and (4) capsules which break when an impact occurs. Preferred devices also may include a bearing member mounted to a lower portion of the steering gear shaft and movably engaged with the mounting bracket.

An impact absorbing device for a steering column of a vehicle according to a preferred embodiment of the present invention will be now described with reference to the accompanying drawings.

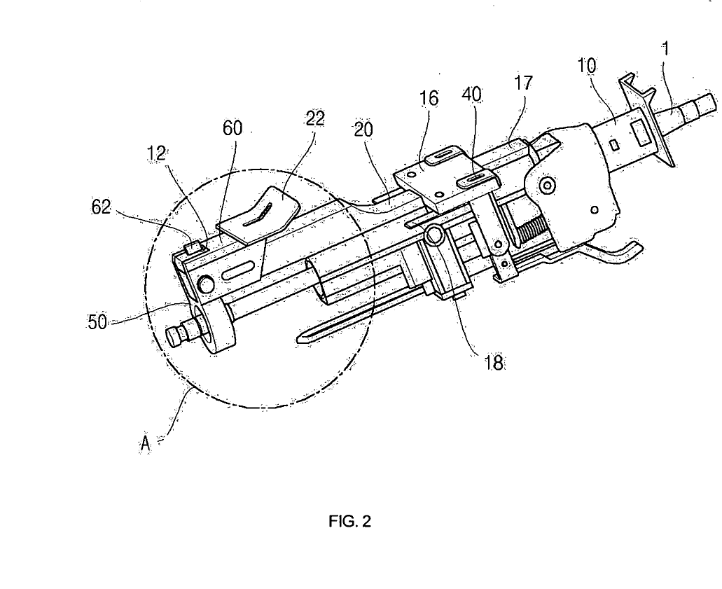

FIG. 2 is a view for showing an impact absorbing device of a steering column according to the present invention. The absorbing device includes a steering shaft 10, a mounting bracket 20, a pipe 30, capsules 40, a bearing member 50, and a connecting member 60.

The steering shaft 10 has a hollow pipe-like shape and is separated from the outer peripheral surface of a steering gear shaft 1 by a predetermined interval.

A steering wheel rotated by operation of a driver is installed at one end of the steering shaft 10 and the mounting bracket 20 is mounted to the other end of the steering shaft 10, so as to surround the outer peripheral surface of the steering shaft 10. The steering shaft 10 is engaged with the vehicle body by a mounting piece 22 provided at the upper portion of the mounting bracket 20.

The mounting piece 22 is installed at the upper portion of the mounting bracket 20 in order to attach the steering shaft 10 to the vehicle body.

A nut hole 12 with which a torque bolt 62, which is broken when an impact occurs, is engaged and a moving hole 14, to which the bearing member 50 is mounted so as to move lengthwise, are provided on one side of the mounting bracket 20. Also, a mounting portion 16, having the capsules 40 on both sides thereof, and curling plates 18 which are installed on both sides of the mounting bracket 20 under the mounting portion 16 to absorb an impact, are provided on the other side of the mounting bracket 20.

It is preferable that the capsules 40 provided at the mounting portion 16 of the mounting bracket 20 are mounted so as to deviate from the mounting portion 16 when an exterior force is applied to the vehicle body and is positioned opposite an adhering portion 17.

The pipe 30 is engaged with the gear shaft 1 and is movably installed to the steering shaft 10. The pipe 10 is separated from the steering shaft 10 by a predetermined interval and is supported by the capsules 40 and the torque bolt 62 in such a manner that it cannot be moved except for when an exterior impact occurs.

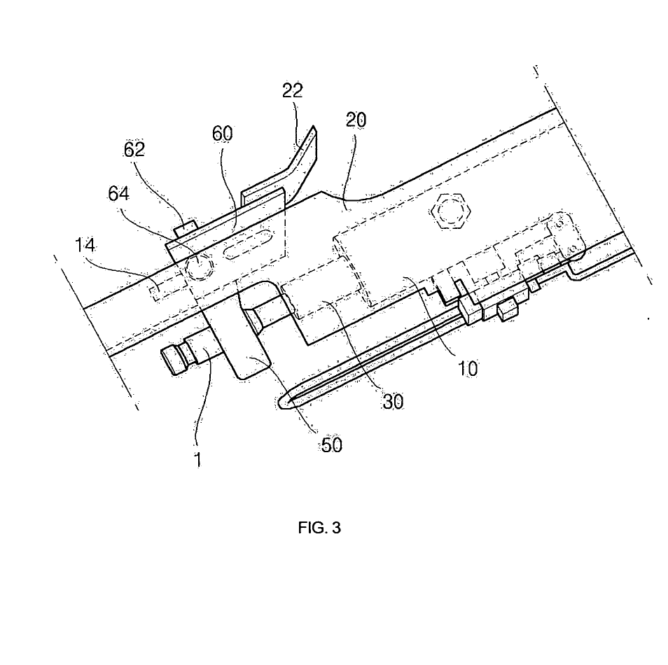

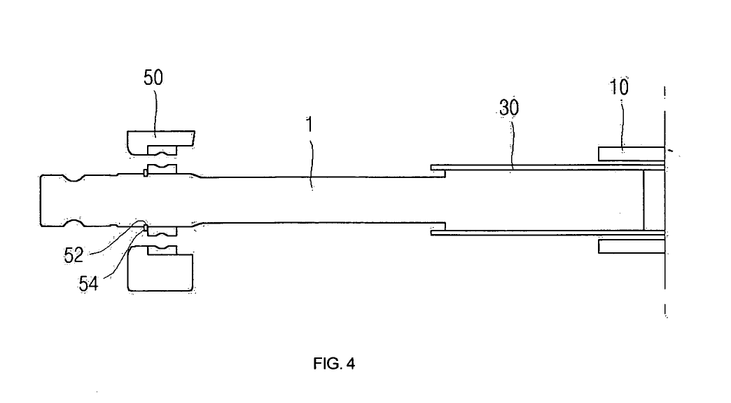

Further, as shown in FIGS. 3 and 4, the pipe 30 is integrally engaged with the gear shaft 1 so as to move together with the gear shaft 1 moved by an exterior impact.

Therefore, the pipe 30 protrudes under the steering shaft 10 together with the gear shaft 1 in a normal state, and enters into and withdraws from the interior of the steering shaft 10 when an exterior impact is applied to the vehicle, as shown in FIG. 3.

The capsules 40 are installed at both ends of the mounting portion 16, which is installed on one side of the mounting bracket 20, and are connected to the pipe 30 so as to be broken by an impact.

It is preferable that the material of the capsules 40 is a synthetic resin.

Therefore, if the capsules 40 are broken by an exterior impact, the impact is firstly absorbed by the withdrawal of the pipe 30 and the residual impact is then absorbed by the resisted sliding of the gear shaft 1 and the pipe 30. Accordingly, the protrusion of the steering shaft 10 into the vehicle is effectively prevented and the impact of the steering wheel, which affects the body of a driver, is reduced.

Since the impact absorbing device of the steering column according to the present invention has a dual breakage structure in which the capsules 40 and the torque bolt 62 are broken simultaneously by an exterior impact, the exterior impact is effectively absorbed.

It is preferable that the material of the torque bolt 62 is the same synthetic resin as that of the capsules 40.

Further, if impact energy is transferred through the gear shaft 1 and the pipe 30, the curling plates 18 are torn in the direction in which the impact proceeds and thus the impact absorbing capacity is doubled, thereby remarkably decreasing the impact transferred to a driver through the steering wheel.

The bearing member 50 is mounted to the lower portion of the gear shaft, is engaged by inserting a fixing piece 54 into a fixing recess 52, and is movably engaged with the mounting bracket 20 by the moving hole 14.

Further, the bearing member 50 is not moved in the lengthwise direction of the gear shaft 1, but rather in the circumferential direction of the gear shaft 1, thereby enabling free rotation of the steering wheel and preventing the driver from moving forward or being separated from the driver's seat.

Both ends of the connecting member 60 is bent to surround a portion of the mounting bracket 20 and one end of the bearing member 50, and a penetration hole (not shown) for mounting a movement pin 50 is formed at one end of each bent portion.

Therefore, the mounting bracket 20 and the bearing member 50 are connected to each other by the connecting member 60.

Here, the connecting member 60 is engaged with the nut hole 12 of the mounting bracket 20 by the torque bolt 62 broken when the vehicle sustains a collision.

The connecting member 60 is located at the lowest portion of the mounting bracket 20 in a normal state, and the torque bolt 62 is broken and is moved upward with the range of the moving hole 14, if an exterior impact is applied.

If the connecting member 60 is moved, the gear shaft 1 engaged with the connecting member 60 by a bearing member 50 is moved and thus the pipe 30 is moved simultaneously, performing the impact absorption of the steering column.

Hereinafter, the operation of the impact absorbing device of the steering column according to the present invention will be described.

When the vehicle travels normally, the steering wheel is rotated by manipulation of a driver to determine the direction in which the vehicle travels. Then, if the vehicle sustains a collision and an exterior impact occurs, collision energy is transferred to the gear shaft 1.

Since before the collision energy transferred to the gear shaft 1 is transferred to the steering shaft 10, the capsules 40 connected to the steering shaft 20 and the torque bolt 62 are broken, the collision energy of the steering shaft 20 is not transferred but rather is absorbed.

When the capsules 40 and the torque bolt 62 are broken, the gear shaft 1 starts to slide along the moving hole 14 formed on one side of the mounting bracket 20.

Then, the pipe 30 is slid along the gear shaft 1, performing the impact absorption of the steering column.

Therefore, since the collision energy resulting from an exterior impact is absorbed by the breakage of the capsules 40 and the torque bolt 62, as well as the slide of the gear shaft 1 and the pipe 30, so that the collision energy is not transferred to the steering shaft 20, the damage of a driver due to the steering wheel is reduced when the vehicle sustains a collision.

In the impact absorbing device for a steering column of a vehicle according to the present invention, the breakage and the slide occur in combination in the case of the collision of the vehicle, thereby preventing the transfer of impact to the steering shaft through the gear shaft. Therefore, the present invention can effectively prevent the excessive impact and injury to a driver, and can prevent interference with surrounding parts such as a brake pedal connected to brackets and an accelerator pedal.

Although an embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An impact absorbing device for a steering column of a vehicle, which comprises:
a steering shaft separated from the outer peripheral surface of a steering gear shaft by a predetermined interval, in which a steering wheel is installed at one end of the steering shaft;
a mounting bracket for attaching the steering shaft to the body of a vehicle, the mounting bracket having a nut hole and a moving hole on one side thereof, and having a mounting portion and curling plates for absorbing an impact on the other side thereof;
a pipe movably installed between the steering gear shaft and the steering shaft;
capsules installed at both ends of the mounting portion and connected to the pipe, the capsule being broken when an impact occurs; and
a bearing member mounted to a lower portion of the steering gear shaft and movably engaged with the mounting bracket by the moving hole.

2. An impact absorbing device according to claim 1, further comprising:
a connecting member connecting the mounting bracket and the bearing member.

3. An impact absorbing device according to claim 1, wherein the pipe is moved by the movement of the steering gear shaft.

4. An impact absorbing device according to claim 1, wherein the pipe is separated from the steering shaft by a predetermined interval.

5. An impact absorbing device according to claim 1, wherein the bearing member is not moved in the lengthwise direction of the steering gear shaft but is moved in the circumferential direction of the steering gear shaft.

6. An impact absorbing device according to claim 1, wherein the connecting member is engaged with the nut hole of the mounting bracket by a torque bolt which is broken when an impact occurs.

7. An impact absorbing device according to claim 1, wherein the material of the capsules and the torque bolt is a synthetic resin.

8. An impact absorbing device according to claim 1, wherein the capsules and the torque bolt are simultaneously broken when the vehicle sustains a collision.

9. An impact absorbing device for a steering column of a vehicle, which comprises:
a steering shaft;
a mounting bracket for attaching the steering shaft to the body of a vehicle and configured to absorb impact;
a pipe movably installed between a steering gear shaft and the steering shaft; and
capsules which break when an impact occurs.

10. The device of claim 9 further comprising a bearing member mounted to a lower portion of the steering gear shaft and movably engaged with the mounting bracket.

11. A vehicle comprising the impact absorbing device of claim 1.

12. A vehicle comprising the impact absorbing device of claim 9.
